(19) United States
(12) Patent Application Publication
(10) Pub. No.: US 2003/0236044 A1
(43) Pub. Date: Dec. 25, 2003

(54) Protective composition and method for manufacture the same

(76) Inventors: Lilya Nissim, Brooklyn, NY (US); Yelena Shifman, Cherry Hill, NJ (US)

Correspondence Address: Lilya Nissim, 2nd Floor, 4650 Bedford Ave., Brooklyn, NY, 11235, US

(21) Appl. No.: 10/465,265

(22) Filed: Jun. 19, 2003

Related U.S. Application Data
(60) Provisional application No. 60/390,088, filed on Jun. 21, 2002.
(60) Provisional application No. 60/403,141, filed on Aug. 13, 2002.
(60) Provisional application No. 60/403,590, filed on Aug. 15, 2002.
(60) Provisional application No. 60/404,342, filed on Aug. 19, 2002.

(51) Int. Cl. B32B 27/04; B32B 3/00; B32B 9/00

(52) U.S. Cl. 442/131; 442/59

(57) ABSTRACT

A protective composition which low heat and cool transfer. This composition can cut to the desired staple length of proper thickness. Protective composition can use for spacecraft to provide from the air heat and decrease air wear when spacecraft is re-entry, and which is very important as we know now.

The composition is use for industry, civil, military and recreational purposes, for instance, blanket including for spacecraft, outer wear for extreme climates (clothing including firefighters protection, apparel, vest, sleeve and glove, mitten, thermal underwear), sleeping and another bags, different container, firefighters protection material which is protect from harmful, environmentally toxic chemicals, ets. This composition can use as firefighters material. The product of protectine composition is technically and cost effective.

### CROSS-REFERENCE TO RELATED APPLICATIONS

With reference to the improvement by this invention, and in the discussion with the follows, attention is directed to the prior art. Many sources exist on synthetic structures used for insulation. One advantage of synthetics lies in the retention of insulation value of protective material. Another advantage of the synthetics protective material is the ability to design “thin” structures which offer significant protection without the large bulk of “downlike” structure protection material. This protection material is well-known. Typically, intelligently designed structures are utilized to minimize the influence of thermal extremes. From sources which we can reach (books, USPTO, WIPO, marketing invention, all of possible manufacturers, product development and prototyping, license this kind of patent, companies seeking new products, website) it is obvious that for any purpose silicon (Si) material for low cool and heat transfer is used like silicium composite and like silicium fiber. Silicon (Si) material property has been taken from http://chemicalelements.com/elements/si.html.

In addition to describing the technology a market in detail, this description of hopped invention provides data analysis and forecasts through the year 2002 on:

market composition and dynamics;

market size;

market participants with related market share;

current and emerging technologies;

trends in utilization of various materials;

impact of and trends in legal and government regulations;

international aspects.

For instance, we used US Government following patens and results in 1790-2002 and part of 2003 db for: “pure silica manufacture” and “molded plate”; “pure silica producing” and “powder plate”; “pure silicon protected composite” and “molded plate”; “protected silicium composite” and “silicium pure plate”; “protected composition” and “plate surrounded inner fabric sewing together with outer fabric”; “multi-layer plate are surrounded inner fabric sewing-with” and “outer fabric sewing with”; “multi-layer protective composition” and “separator inside of protected plates”; “multi-layer protective composition” and “bonded layers”; “material which consists of silicon fiber; “material” and “consists of silicon fiber”; “protected material” and “consists of silicon fiber”; “protected silicon material” and “consists of silicon fiber”; “silicon material” and “reinforced silicon fiber”; “silicon material” and “mainly bonded silicon fiber”: 0 patents, no patents have matched all of this kind of query.

For instance, for material, composite we have used U.S. Pat. Nos. 5,502,937; 5,722,482; 5,837,625; 6,183,855; 6,319,599; 6,254,652; 6,237,208. For example, protected material for clothes, mittens, gloves, firefighters material has two sources: (1) Special report industrial fabrics: Industrial Textiles Thrive Through Technology. Published Feb. 01, 1999 by William C. Smith and John W. McCurry, source: Magazines. (2) The complete fabric dictionary. (Fabric used in outdoor clothing and gear)(Apparel Buer's Guide '95). Published Sep. 01, 1996 by none, source: Magazines. For element of thermal insulation we have used U.S. Pat. Nos. 5,799,457; 5,822,938. For example, Advanced Flexible Reusable Surface Insulation (AFRSI) blankets as an application of protective material consists of low-density fibrous silica batting that is made up of high-purity silica and 99.8-percent amorphous silica fiber (1 to 2 mils thick).

The AFRSI composite density is approximately 8 to 9 pounds per cubic foot and varies in thickness from 0.45 to 0.95 inch. The thickness is determined by the heat load the blanket encounters for spacecraft during re-entry. For fabric we have used U.S. Pat. No. 5,948,707. The sewn quilted fabric blanket is manufactured by Rockwell in 3- by 3-foot squares of the proper thickness. The blanket are cut to the platform shape required and bonded directly to the orbiter by RTV silicon adhesive 0.20 inch thick. The very thin glue line reduces weight and minimizes the thermal expansion during temperature changes (Scientific American, Inventions, From Outer Space: Every Day Uses For NASA Technology, February 2000/David Baker, p. 64: Thermal Protection System). For instance, U.S. Pat. No. 5,074,090 which have title “Self-supportive reflective insulation” which reflective unit has a right frame consisting of a four-sided corrugated cardboard structure which is generally rectangular in cross-section, the top and bottom being sized to closely fit within the dimensions of a construction bay. Also there is new material called Demron which is founded by Radiation Shield Technologies Company. This material has a small weight first of all (Russian newspaper published in US “Russian Reclama”, # 9 (515), Feb. 28-Mar. 6, 2003, page B25). Before has used heavy metallic shields for radiation which held x-ray and γ-beem using big atoms metals with number of electrons in each. Now developers of Radiation Shield Technologies said that developed polymer imitating the same properties because molecules of this polymer are created electronic clouds to protect radiation as do it heavy metallic material before. As an application is U.S. Pat. No. 5,978,964 which have title “Exercise apparel and associated weight” which sportswear garment manufactured from a form fitting clothing article having at least one flexible weight and plurality of pockets. The flexible weight may have flexible metal core surrounded by a cushioning layer and/or a plastic coating on the cushioning layer. For instance, U.S. Pat. No. 4,304,817 discloses bats of crimped polyester fiber one component of which being slickened with a durable coating, and one component being unslickened, and third component being a binder fiber. These bats may be used for apparel insulation. U.S. Pat. No. 4,167,604 discloses a mixture of down and synthetic hollow staple fiber impregnated with a thermosetting resin. The utility is in sleeping bags, ets. Various types of hollow fibers have been used in synthetic insulation. U.S. Pat. No. 3,772,137 discloses high loft structures made from hollow fibers and EPA 82303034.1 discloses improved hollow polyester fibers for softer insulation. The EPA fiber contains four continuous hollow sections with a total void fraction of 15 to 35%. U.S. Pat. No. 4,395,455 discloses the use of thin layers of metal foils between layers of fibrous materials to reduce the radiation component of heat transfer in thermal insulation for apparel. U.S. Pat. No. 4,395,455 discloses a cohesive fiber structure comprised of 70-90% of micro fibers with a diameter of 3-12 microns, 5-30% of micro fibers having a diameter of 12-50 microns wherein some of the fibers are bonded. Thermal conductivity like down are reported. U.S. Pat. No. 4,136,222 discloses a thermally insulating sheet material comprised of a specially reflecting film (open or closed to air) attached to a foam array covering only about 40 to 90% of the available area. U.S. Pat. No. 5,102,711 discloses a self bonded nonwoven web and porous film composite where the nonwoven web is made from continuous filaments. U.S. Pat. No. 5,043,209 discloses a laminated clothing liner comprised of a perspiration absorbing layer on the outside and a breathable film on the inside layer. We only select the U.S. Pat. No. 5,834,120 of Murray, et al., published Nov. 10, 1998 and which has title “Fire protection material”, provided for protecting electrical cables and components, and which comprises an endothermic-reactive insulating fibrous material including an inorganic endothermic filler which undergoes multiple endothermic reactions between the range 100.degree.C. and 750.degree.C.; inorganic fiber material, and an organic polymer binder. It will be apparent that any fine porous silicon (Si) can be employed in conjunction with either of the other a few expedients used to reduce heat transfer. This fine porous silicon (Si) is heat treated by heat fire. A firefighters material density is approximately 5 to 7 pounds per cubic foot.

Also we saw at the Web site followings cases which are above mentioned and following additional publications also have some relationship to this subject. But these sources are not as pertinent to the subject matter of this invention, however most of them dealing may be on our maind with another substance of matter, not so close as present invention:

About NASA silica protected material. All of them are 894 matches. We took only a few of them, we think most important.

(a) http://Imms.externalImco.com/newsberau/pressreleases/1922/9222.html: . . . Endevaur will be protected with over 26,000 tiles . . . work focused on finding a suitable all-silica material . . . during the reentry of NASA's Pasemaker spacecraft.

(b) http://Imagine.gsfc.nasa.gov/docs/ask astro/answers/970804a.html: . . . Cosmonauts and astronauts.

(c) science.ksc.nasa.gov/shuttle/technology/sts-newsref/sts sys.html: . . . and the metallic attachments must be protected from exceeding . . . FRCI tiles were developed by NASA's Ames Research . . . called Nextel, to the pure silica tile slurry . . .

(d) si.ksc.nasa.gov/specsintact/masters//NASA%20masters/NASAKSC/pdf/09915 PDF: . . . KSC AND SPACE ADMINISTRATION SUPERSEDING NASA-09915 (MARCH . . . WHEN IT IS ABRASIVE BLASTED WITH SILICA SAND . . . coated surfases shall be adequately protected from damage . . .

(e) www.centennialofflight.gov/essay/Evolution of Technology/TPS/Tech41.htm: Shuttle Thermal Protection System (TPS)— . . . they could use materials and techniques that protected the vehicle . . . during the 1960s, Lockheed developed a silica-based insulation material for NASA . . .

(f) www.jpl.nasa.gov/releases/95/release 1995 9514.html: . . . landscape, its delicate electronics wil be protected by a . . . insulation was also a form of silica, but powdered so . . .

(g) www.uark.edu/misc/hera/prot-curation.html: science— . . . comet's tail will be collected in silicaaerogel and . . . NASA is also beginning to plan a comet nucleus . . . the terrestrial environment must be protected from possible . . .

(h) lwww.nap.edu/books/0309059887/html/7.html: Protecting the Space Shuttle from Meteoroids . . . — . . . crew, structure, cause, space, NASA, mission, aft . . . forward, debns, heflin, nose, silica, panes, replaced . . . predictions, mass, covered, protected, ORDEM, paint . . .

(i) www.wired.com/wired/6.08/materials pr.html: 6.08: Features— . . . Made from a maze of silica strands only one one . . . NASA developed the substrance as a coating that would warm . . . But the paint is not UV protected and costs too much . . .

(j) cst-www.nrl.navy.mil/6600/6610/publications/NSREC97 Low E prot.pdf: Proton Displacement Damage and Ionizing Dose for Shielded Devices , , , (PDF)— . . . orbits, we show results for a cell protected by a . . . is taken to be equivalent 60 mil thickness of silica . . . Protected Against Radiations in Space. NASA-SP-71, 1964 . . .

(k) ocga2.uscd.edu/briefing//062395.html: . . . Evaluation of Substitute Material for Silica Sand in Abrasive Blasting, Study of Worker . . . NASA has also . . . thermally sensitive electronics protected inside the . . .

(l)www.tms.org/pubs/journals/JOM/9602/Scala-9602.html: A Brief History of Composites in the US— . . . in FIG. 2), composed of a silica-Inconel composite . . . the composite . . . HI wire was the NASA space tether . . . strength of 400 pounds minimum is protected from ultraviolet . . .

(m) www.nasatech.com/Briefs/Dec02/ARC 14051 .html: Deforming Fibrous Insulating Tiles To Fit Curved Surfaces— . . . A curved tile of refractory silica-fiber-based or alumina . . . to the curved surface to be protected by the . . . This invention has been patented by NASA . . .

(n) www.ngi-supernet.org/ngi.pdf: Microsoft PowerPoint—ngi.ppt (PDF)— . . . only over 1535-1610 nm. Othermaterial systems/technologies . . . to fill low-loss band in silica fibers of . . . Bell Atlantic Central Offices DIA NRL NASA NSA DISA . . .

(o) www.lts.caltech.edu/-gas/G056 SDP.doc: NASA Small Self-Contained Payload Program— . . . a thickness of 0.25 inches and is made of fussed silica . . . Each battery is protected by a Schottky diode to . . . has been submitted, reviewed, and approved by NASA /GSFC . . .

(p) powerweb.grc.nasa.gov/pvsee/publications/mars/techn.html: Materials Adherence Experiment— . . . Mars Pathfinder, NASA's first Marslander since the Viking-2 . . . the sky and the other is protected from the . . . Suprasil , a high quality fused silica, manufuctured by . . .

(q) www.cyrospace.com/fuatured/photanic.htm: Cyrospace Inc.— . . . Technology is protected by two patents (issued to the . . . Cyrospace and NASA researchers have performed computer . . . Low (T sensetive), Medium (6 ms, silica), Medium (10 ms . . .

(r) www.irs.uni-stugart.de/M|TARBEITER/LAUX/14 42 p irs.pdf: ITRM X-38 R-TPWTS (PDF)— . . . YTTRIUM-SILICATE COATINGS WERE TESTED: tHE SILICA-RICH MATERIAL . . . to the vacuum system and protected against heat . . . experimental re-entry vehicle by NASA, named X . . .

(s) www.jsc.nasa.gov/h|story/suddenly tomorrow/Chpt12.pdf: Chapter 12 qxd (PDF)— . . . Despite the fact that the science, defence, aerospace contractor, and NASA commun—ities became less divisive . . . Silica-fiber based tiles protected with a . . .

(t) http://composite.about.com/library/PR/1999/blameron1.htm Ameron Develops Protective Coating for NASA.

(u) aerade.cranfield.ac.uk Subgect listing for materials: Home about AERADE AERADE update New resources Suggest a site contact us Help Materials A Damage Dependent Finite Element Analysis for Fiber-Reinforced Composite Laminates: Published by Timothy W. Coats; Charles E. Harris. Report number(s): SAE Paper.

About Protective materials (Products) All of them (NASA TechFinder) are around 792 matches (Technologies). We took only 15 of them, we think most important.

(a) www.packworld.com: Protective materials

(b) Carbonyte Systems, Inc. www.carbonyte.com:

The Technology of Space Travel brought down to Earth 916.387.0316 Presents TM Investment Grade Sealcoat All other sealcoats are obsolete! Learn how SteelGuard can make sealcoating at night a realitiy!

(c) products.mmm.com: Protective Materials Division

(d) Warwick Mills, Fiber Solutions and Performance Substrates, TurtleSkin puncture resistance fabrics. www.warwickmills.com: Warwick Mills, High performance weavers of Nomex, Vectran, and Kevlar. From the sails on America's Cup racing yachts to the blimps flying over the SuperBowl, you'll find Warwick's products

(e) Protective materials (Products) www.packworld.com: Protective materials

www.nlectc.org: Title: Ballistic Resistant Protective Materials Series: N/A Author: NIJ Published: September 1985 Subject: police equipment pages.

(g) New York Concrete. www.thebluebook.com: Blue Book Ad for Protective Materials Company Inc. Under Concrete Repair & Restoration Materials.

(h) Chris Woodford: Samples: Protective materials www.chriswoodford.co.uk:

The human body's remarkable design can protect against heat and cold, cushion blows, and even repair its own injuries. But it has not evolved fast enough to keep pace with the threats posed by humankind's more recent inventions.

(i) Protective Clothing Systems and Materials at Amazon.com www.amazon.com:

Only books. Protective Clothing Systems and Materials and find more books by. For a limited time,

(j) Manufacturer of protec (j) www.wilsoncase.com tive/reusable material. Offering free custom design. Featuring the Wilson LT—a tough, lightweight case material.

(k) Material Handling Products. www.dawginc.com: Dawg (Doing Away With Grime) is your guaranteed low-cost source for material handling products—drum moving products, spill containment, absorbents, protective clothing and more.

(l) Gourock Sport and Specialty Netting www.gourock.com: Gourock is a leading manufacturer of netting and rope products. We supply barrier, protective and sport netting for any application. Custom made nets and panels are our specialty.

(m) amptiac.allorisclence.com/pdf/2000Material|Fase11.pdf: Because of this porous nature, the tiles used . . . and made up of 99.8% pure silica fibers . . .

(n) nitzy.mse.nitech.ac.jpt/Nogamilab/summary98.htm: Poly (N-vinyl 2-pyrrolidone) (PVT)-protectedgold (Au) clusters incorporated into silica (SiO₂ . . . How to made SiO₂ to Silica?

(o) www.reviewmakers.com/news/arcf0-2001.php: . . . The comprehensive review site for the latest . . . — . . . to continue to share copyright—protected material using the . . . forms extremely small silica sphres, like . . . the sphres, an extremely porous material, reffered to . . .

About Clothing Systems and Silica Porous Undercover Protected Material. All of them (Yahoo Search Results) are around 146 matches (Web). We took only 10 of them, we think most important.

(a) www.amazon.com: Only books. Protective Clothing Systems and Materials and find more books by for a limited time.

(b) www.cti-corp.com/news.html: Concrete Technologies Incorporated— . . . it's no longer porous.”. . . Installed to offer the option of clothing the undercover area off, the soft . . . About ⅛-inch of silica-sand latex base is poured on the . . .

(c) csd.unl.edu/csd/illustrations/ec10/ec10.html: Geology, Geologic Time and Nebrasksa— . . . Undercover Nebraska . . . of nodules of chert-a dense rock composed of silica (good arrowhead . . . vast deposit of sand and gravel now provide the porous container for . . .

(d) www.ircscotland.net/technology trade/latest techalert.cfm?IncCategoryID=29: Innovation Relay Centre (IRC) Scotland—Technology Trade— . . . — . . . print electrical conductive incs into porous materials (namely . . . shoes, clothes, accessories, for clothes and bath . . . membrane of polyethylene and silica, to strong . . .

(e) www2.exlibris.com/bookstore/book exerpt.asp?bookid=2102: Medallion Solution The Sick Home Syndrome Epidemic of the 21st . . . — . . . to sant it, it will Introduce silica into the . . . in clothes closet, they will attack the smelly . . . on biological contaminantsembedded in porous material such as . . .

(f) www.agralin.ml/prosrom/tectona.html: PROSEA—Sample record from CD: tectona— . . . dye which used for paper, clothis and matting . . . Woodring-porous; earlywood vessels extremely large to . . . Vitreus silica present in some vessels and parenchyma . . .

(g) www.1011.com/txt s/it bus desc en.htm: Category; Sub Categories, company, Name, Address, County, Phone, Fax, . . . — . . . Manufacture and trading of synthetic silica carbide abrasive . . . single or double abrasives, porous or non-porous . . . and world-wide: work clothes, accident safety . . .

(h) www.bgr.de/icom2000/poster.htm: ICAM2000 Poster, Author's index— . . . up to 800?C. dence amorphous silica bodies containing . . . glass and sodium water glass gives porous ceramic materials . . . bring sun to dry cleaned clothes, and the . . .

(i) www.iosh.gov.tv/eversion/yrep1998/yr1998ann.htm: IOSH Annual Report 1998— . . . workers are exposed to cristallized free silica . . . either vapor of working clothies under different humidity . . . This research project uses porous material to fabricate . . .

(j) josephcoates.com/pdf files/2025/2025—Ch 6.pdf: 2025—Ch. 6 The World of Things (PDF)— . . . SHIFT IN MATERIALS TECHNOLOGY Fundamental shifts in the material world over . . . long they have owned their cars, refrigerators, watches, clothes, computers, etc. . . .

About Silica Porous Gloves and Mittens Protected Material. All of them (Yahoo Search Results) are around 103 matches (Web). We took only 8 of them, we think most important.

(a) www.nitriledirect.com: Protective gloves, made from 100% hypo-allergenic nitrile—a superior chemical and puncture resistant material.

(b) history.nasa.gov/stst/pages/tps.html: This material was 89 persent porous, had a density . . . by DuPont) and a mixture of silica and water . . . the wing leading-edge clousout, wing glovewindshield closeout . . .

(c) www.globalsecurity.org/space/library/report/1988/sts sys.html: SPACE SHUTTLE ORBITER SYSTEMS— . . . trailing edges of the vertical stabilizer; wing dlove areas; elevon . . . is frame-cast to form soft, porous blocks to which a collodial silica binder solution is . . .

(d)www.emmessar.com/chemical/patents/homeopathicpatents/page17.html: Disperser for at least one liquid or pasty product comprising a . . . — . . . support can be chosenfrom among porous products forming a group that comprises minerals such as silica, limestone, the . . . like the finger of a glove, a component . . .

(e) ag.arizona.edu/ceac/basics/notes/chapter4.pdf: INTRODUCTION* Plants need to be protected against several . . . Preventative Silica sand can be put on the surface . . . disinfectant mats, fool/hand/glove cleaning and . . .

(f) www.hcc.hawaii.edu/hcconline/gg101/program17%20VolcanicFeatures/program17.html: . . . Therhiolitic magmas are very richin silica and poor in . . . The glove in this picture is for scale . . . Since the surface clincer is very poor and very rough . . .

(g) www.workcover.vic.gov.au/vwa/vwacop.nsf/COP/52C8212D96A3036D4A25668E00142933/$File/COP2PDF: Code of Practice (No. 02) Foundries 30 Jun. 1988 (PDF)— . . . or other substances containing free silica should not be . . . Industrial Safety Gloves and Mittens', to emploees . . . Where possible, porous change or scrap, which may . . .

(i) secretanat.etta.int/Web/ExtemalRelations/PartnerCountries/MA/Annexes/08-Annex %20 1i1-Table%20B.PDF: . . . 37.01 Photographic plates and film in the flat sensitised, unexposed, of any material other than paper, paperboard or textiles; instant print film in the flat . . .

About silica porous blanket made from protected material. All of them (Yahoo Search Results) are around 191 matches (Web). We took only 15 of them, we think most important:

(a) www.ca.nrcs.usda.gov/mlra/wmendo/glossary.html: Soil Survey of Mendosino Co., CA, Western Part— . . . An area of porous forest soil with a protective . . . and to facilitate the movement of firefighters and equipment . . . is cemented by iron oxide, silica, carcium carbonate . . .

(b) soil.usda.gov/soil survey/surveys/fl calhoun/web/glossary.html: Glossary— . . . and to facilitate the movement of firefighters and equipment . . . is cemented by iron oxide, silica, carcium carbonate . . . such applicators as emitters, porous tubing, or . . .

(c) www.state.nj.us/helth/eoh/peoshweb/fireresp.pdf: Model Fire Dept Resp Prot Prog (PDF)— . . . Program Monitoring Periodic monitoring of the respiratory protection program is necessary to ensure that all firefighters are adequately protected . . .

(d) www.rand.org/publications/CF/CF176/CF176.pdf: Brian A. Jackson, D. J. Peterson, James T. Bartis, (PDF)— . . . incurred and the human and material resources needed . . . Conversely, firefighters became engaged in activities they . . . and assuring that all were properly protected . . .

(e) www.adpc.purdue.edu/PhysFac/rem/home/booklets/RPP98.pdf: PURDUEUNIVERSITY Respiratory Protection Program Revised March . . . (PDF)— . . . Management shall obtain from a licensed physician a written option which states whether the employee's helth is at increased risk of material impairment from . . .

(f) www.bbep.org/char rpt/ch4/chapter4 text.htm: I— . . . the often brittle, impure, and somewhat porous pig iron . . . range from fine-grained, high silica sands to . . . so fast that the lives of firefighters were threatened . . .

(g) www.unesco.org/webworld/ramp/rtf/books/r8707e.rtf: (RTF)— . . . fire-proof buildings and professional firefighters (3). On . . . meaning: rapid freezing of a material at a . . . distributed, the remaining residue highly porous with the . . .

(h) www.army.mil/usapa/doctrine/DR pubs/dr a/pdf/fm3 11.pdf: Page 1 (PDF)— . . . This manual does not implemented any international standartization agreements; however, the material within the manual is in accordance with related . . .

(i) ntl.bts.gov/DOCS/5200-30a.html: Airoport Winter Safety and Operations—AC 150 5200-30A— . . . taxiways to the ramp area, emergency or firefighters' access roads . . . (2) Porous Friction Course . . . Sharp, hard silica sand provides the greatest increase in traction . . .

(j) www.rdc.nasa.gov/˜amd/sbir00.pdf. Small Business Innovetion Research (PDF)— . . . Each proposal should be checked carefully by the offeror to ensure enclusion of all essentual material needed for a complete evaluation . . .

(k) registrar.duke.edu/bulletins/Nicholas/2002-03/EnvBull2002-03.pdf: Duke University2002-3 (PDF)— . . . Page 1. Bulletin of Duke University 2002-2003 Nicholas School of the environment and Earth Science Page 2. The Mission of Duke University . . .

(l) www6.semoedu/.riskmanagement/pdf files/SEMO Resp prot prg.pdf: RESPIRATORY PROTECTION PROGRAM FOR SOUTHEST MISSOURISTATE . . . (PDF)— . . . in this proper use proseduries section is mean to preclude firefighters from performing , , , must be done properly to ensure that the equipment is protected and not . . .

(m) www.csupomona.edu/˜ehs/ftp/Respiratory%20Protection.doc: TABLE OF CONTENTS— . . . hazard against which employees are to be protected . . . when they are exposed to hazardous material spills . . . section is meant to preclude firefighters to performing . . .

(n) www.uscg.mil/mlclant/Kdiv/docs/kse/1910%20Subpart%201.pdf: OSHA Regulations (Standards—29CFR) Table of Contents for Part . . . (PDF)— . . . Note 2 to paragraph (g): Nothing in this section is meant to preclude firefighters from performing emergency resque activities before an entire team has . . .

(o) www.nyenvirolaw.org/PDF/POGO-1-14-03-ForumOnEPAombudsman-Testimony.pdf: pogo.org Written Statements of Community Members Participating in . . . (PDF)— . . . The hearings developed extencive testimony contradicting Mr. Whitman's assertions, from scientists, citizens firefighters and other cleanup workers, doctors . . .

Ballistic Resistant Protective Materials All of them (Yahoo Search Results) are around 191 matches (Web). We took only 1 of them, we think most important.

(a) www.nlectc.org: Title: Ballistic Resistant Protective Materials Series: N/A Author: NIJ Published: September 1985 Subject: police equipment pages.

### FEDERALLY SPONSORED RESEARCH OR DEVELOPMENT

The present application is a Continuation of:

(1) application No. 60/390.088, filing date Jun. 21, 2002, confirmation # 8268, date mailed Jul. 15, 2002, entitled: “THE PROTECTIVE COMPOSITION AND METHOD FOR MANUFACTURE THE SAME,” license for foreign filing under title 35, United States Code, Section 184 Title 37, Code of Federal Regulations, 5.11 & 5.15,

The present application is a Continuation in Part of:

(1) application No. 60/403.141, filing date Aug. 13, 2002, confirmation # 1470, date mailed Sep. 03, 2002, entitled “Protective blanket”, license for foreign filing under title 35, United States Code, Section 184 Title 37, Code of Federal Regulations, 5.11 & 5.15,

(2) application No. 60/403.590, filing date Aug. 15, 2002, confirmation #3582, date mailed Sep. 25, 2002, entitled “Protective clothing”, license for foreign filing under title 35, United States Code, Section 184 Title 37, Code of Federal Regulations, 5.11 & 5.15,

(3) application No. 60/404.342, filing date Aug. 19, 2002, confirmation #9170, date mailed Sep. 26, 2002, entitled “Firefighters material”, license for foreign filing under title 35, United States Code, Section 184 Title 37, Code of Federal Regulations, 5.11 & 5.15.

### BACKGROUND OF THE INVENTION

1. Field of the Invention

The present invention relates to protective composition which is low heat and cool transfer. More particularly to improvements in protective composition which be applied to solve a problem of climate control for products or for personnel which are exposed to extreme environments.

### BRIEF SUMMARY OF THE INVENTION

### BRIEF DESCRIPTION OF THE SEVERAL VIEWS OF THE DRAWINGS

On the every pictures the number before dot is mentioned the number of this certain figure, and after dot is mentioned the number at this certain figure. Reference being made to the accompanying drawings of the present invention in which:

at the FIG. 1—is a schematic cross section in rectangle form made of protective composition;

at the FIG. 2—is a schematic cross section in square form made of protective composition;

at the FIG. 3—is a schematic cross section in circle form made of protective composition;

on the FIG. 4—is a schematic cross section in threeangle form made of the same.

There are together FIGS. 5A to 5B cross sectional view of protective composition where FIG. 5A is a cross section of the protective composition in square form one layer; and FIG. 5B is a cross section of the protective composition in rectangle form a few layers.

There are together FIGS. 6A to 6B cross sectional view of protective composition where FIG. 6A is a cross section of the protective composition one layer in rectangle form sewing up together, and FIG. 6B is a schematic of cross section of the protective composition a few layers in rectangle form sewing up together as well, and a cower both sides.

There are together FIGS. 7A to 7B a plain view of protective blanket made of protective composition where on the FIG. 7A is a plain view of protective blanket cutted to square form (A=A); on the FIG. 7B is a schematic of plain view of protective blanket cutted to rectangle form (A≠B).

There are together FIGS. 8A to 8B a view of protective clothing made of protective composition where FIG. 8A illustrates possible cross section of protective jacket made of protective composition; and FIG. 8B illustrates a schematic possible view of protective trousers applications of protective closing made of protective composition.

FIG. 9 illustrates the schematic possible cross section of protective bottle made of glass or metalic bottle actually, and outside is protective composition.

FIG. 10 illustrates the schematic possible cross section of protective heat or cool sleeping bag made of protective composition.

### DETAILED DESCRIPTION OF THE INVENTION

Recent techniligical advances, particularly in the area of insulation and amplification methods, have allowed for more specificity and superior products. The present invention provides structures which possess all of the advantages of insulations.

The main, general advantage of protected composite is insulation properties, for instance, Si protective porous sections are working as protective sections after sifted particles of silicon Si which then“opened” as a “pop corn”. Only after that and heat treated we can use light weight of silicon Si protective porous sections to be strong enought.

It is second advantage of Si protective porous sections. To do that protective porous sections made of silicon Si not only sifted accordingly, but heat treated also when we all of sifted particles of silicon Si are “opened” as a “pop corn”. Before particles of silicon wether sifted approximately from 0,2 to 1.0 mm and then using silicon Si protective sections, when the inflow temperature to silicon particles can be adjusted to approximately 1,370.degree.C.-1,400.degree.C. during 0.7-1.0 hours. The protection section to a three dimentional enlarge process for a rest time of, for example, about 1.5 to about 2.0 hours being enought to obtain a considerable amount. Those protective sections of silicon sand reduces cost and minimize noise as well.

The third advantage of Si protective porous sections that they surrounded each section by interior protective fabric, and all of protective porous sections surrounded common case whole the same exterior protective fabric. This is protected from separation of actually separated Si “opened” protective particles of Si protective sections.

The forth advantage of Si protective porous sections that they heat trited. This is also protected from separation of actually separated Si “opened” protective particles of Si protective sections, and increase mechanical properties of protective sections as well.

The fifth advantage of Si protective porous sections that they are reinforced by fibers bonded to Si “opened” protective particles. This is protected from separation of actually separated Si “opened” protective particles of Si protective sections, and also increase mechnical properties of protective sections as at the forth advantage of Si protective sections.

The exterior protective fabrics is also heat treated to be strong as well. Therefore mechanical property of exterior protective fabrics can be increased approximately by 15-27% comparison with mechanical properties of protective sections before.

The sixth advantage of Si protective porous sections is follow. These both interior and exterior protective fabrics are easy air penetratable fabrics. Each interior fabric and each exterior surrounded protective fabric are sewing up together. Also we have shown interior sewing up and exterior sewing up fabrics. Last sewing fabric is twice rapped up outer protective fabric, protective sections and inner protective fabric which protective sections already make of protective composition.

The seventh advantage of Si protective porous sections is follow. The protective composition may have coating. This coating can use only one side in this particular case as needed or reduce cost, or two, both sides in common case. Also this protective coating may be smooth and/or reflective coating which have only one goal for NASA orbiter—to decrease air wear when spacecraft is re-entry. This property of coating is very important as we know it for sure now.

The eighth advantage of Si protective porous composition is follow. The protective composition is easy to use in some products out of inner protective fabrics. It also reduces cost as well of these products.

The last advantage of Si protective porous sections is follow. Sometimes is used screw-type extruder which is fed with pellets of silicon Si “opened” as a “pop corn”. This is eliminate needed sift of silicon particles granularity with the necessary level of Si protective porous sections.

The present invention provides structures above which possess all of the advantages thin insulations and which have decreased thickness retention when compressed. The pressure of the protective sections that is supplied to the next preform is used for the release of a preliminary sections and can be adjusted to approximately 5-350 bar. The weight of protected sections is reducing from 25 to 68%.

In FIGS. 1 to 6 we have shown one of the embodiments of the protective composition of the present invention. The protective porous sections 1.2, for instance, silicon Si sifted accordingly and heat treated accordingly is shown at FIGS. 1 to 6 by 1.2 to 6.2 according to these figures. It will be apparent that any protective porous sections can be employed in conjunction with either of the other a few expedients used to reduce heat and cool transfer. To do that protective fine porous sections 1.2 made from silicon Si not only sifted accordingly, but heat treated also when all of sifted particles of silicon Si are “opened” as a “pop corn”. Particles of protective sections wether sifted approximately from 0,2 to 1.0 mm and then using silicon Si protective sections, when the inflow temperature to silicon particles can be adjusted to approximately 1,370.degree.C.-1,400.degree.C. during 0.7-1.0 hours as above. Hereof protective composition protect areas where temperature are bellow 1200° C. The protection section to a three dimentional enlarge process for a rest time of, for example, about 1.5 to about 2.0 hours being enought to obtain a considerable amount of the overall three dimentional enlarge of silicon Si protective porous sections to be expected (the melting point is 1,410.degree.C. according to properties of silicon). Or protection sections made from silicon particles which are not sifted, but use before the above heat treatment a SINGLE-screw-type extruder described at the U.S. Pat. No. 6,237,208. This type of extruder is preferably used as a the screw-type extruder, in any case, when screw-type extruder is fed with pellets of silicon Si “opened” as a “pop corn”. Dimensions of a SINGLE-screw-type extruder are given at the U.S. Pat. No. 6,237,208 as well. The volume of silicon Si “opened” particles is increased approximately in 2 or 3 times comparison of Si particles. Only after that we can use light weight of silicon Si protective porous sections to be strong enought. When using silicon Si protective sections, the inflow temperature to silicon particles can be adjusted to approximately 1,370.degree.C.-1,400.degree.C. during 0.7-1.0 hours as above, and rest time can for example ammount to approximately 1.5 to 2.0 hours. The weight of protective sections is decreased approximately by 75-80% in this case comparison with weight of silicon particles. The mixture is preformed, and then heated as above. Preform of Si “open” spheres is realized at room temperature 68 F. (20° C.) unstead of U.S. Pat. No. 6,110,527. Also pure silicon to be manufactured in a totally dirt-free environment is not producing atmospheric pollution (Scientific American, Inventions, From Outer Space: Every Day Uses For NASA Technology, February 2000/David Baker, p. 92). Those protective sections made of silicon sand reduces cost and minimize noise as written above.

This porous protective sections surrounded interior protective fabric which is shown at FIG. 6B as 6.3. This interior protective fabric 6.3 is also heat treated as above to preform and hold desired shape of protection sections. The protective composition is surrounded exterior also protective fabrics 6.1. This exterior protective fabrics 6.1 is also heat treated for the same reason as interior fabric above. Therefore mechanical properties can be increased approximately by 15-27% comparison with mechanical properties of protective sections before treatment. This exterior protective fabric have shown on FIGS. 1 to 6 as 1.1 to 6.1 according to these figures. These both interior and exterior protective fabrics are also easy air penetratable fabrics. Each interior fabric and each exterior surrounded protective fabrics are sewing up together by treated, for instance, silicon treated consist of silicon fibers. Then this protective composition is sewing up together, for instance, silicon fiber as well. For fiber we have used, for instance, US patents as follows: U.S. Pat. Nos. 5,527,597; 5,614,449; 5,723,209; 5,945,215; 5,993,964; 6,110,527; 6,129,879.

At FIGS. 5 from A to B on each we have shown one of the embodiments of the protective composition of the present invention. There in FIG. 5A have shown this protective composition which consist of one layer of fine porous protective sections 5.2, for instance, silicon (Si) section in square form. There also in FIG. 5B have shown this protective composition which consist of few layers of protective sections 5.2 in rectangle form, for instance, silicon (Si) sections.

On the FIGS. 6A and 6B we have shown another approach of invention to reducing heat and cool transfer of the protective composition of the present invention where 6.3 is inner fabric, for instance, silicon (Si) fabric, local wrapped up interior protective sections 6.2, and exterior protective fabric 6.1, and then all of them sewing up together. The sewing line have shown as doted line. And at the FIG. 6A we shows interior sewing up—6.3 and exterior sewing up—6.4 fabrics. Last sewing fabric 6.4 also make twice rapped up outer protective fabric 6.1, protective sections 6.2 and inner protective fabric 6.3 make protective composition. The protective composition may have coating 6.5 on FIG. 6B. This coating 6.5 can use only one side in this particular case to reduce cost, or two, both sides, as shown at FIG. 6B in common case. Also this protective coating 6.5 may be smooth and/or reflective coating which have only one goal for NASA orbiter—to decrease air wear when spacecraft is re-entry. This property of coating is very important as we know it for sure now. Protective coating 6.5 may be made from alumina (Al), or soldering, for instance, U.S. Pat. Nos. 4,136,222; 4.167,604; 4,304,817; 6,254,923. Each protective sections can be reinforced by fibers, for instance, silicon Si fibers (is not shown at any figures). Tereof protective composition temperature is equal fibers temperature and temperature of protected sections, and equal 1200° C.

There on FIGS. 7A and 7B have shown a protective blanket cutted to square form (A=A) or to rectangle form (A≠B) where above mentioned values of 100-150 mm, preferably 100 mm, because silicon particles to be separated can more easily to be separated from the silicon fibers.

FIG. 8A illustrates possible cross sectional view of jasket made from protected composition, where 8.1 is a protective sections of protective composition, and 8.2 are the outer protective fabric; and FIG. 8B illustrates possible trousers applications of protective clothes which may have layer of breathable film as disclosed in U.S. Pat. No. 5,043,209.

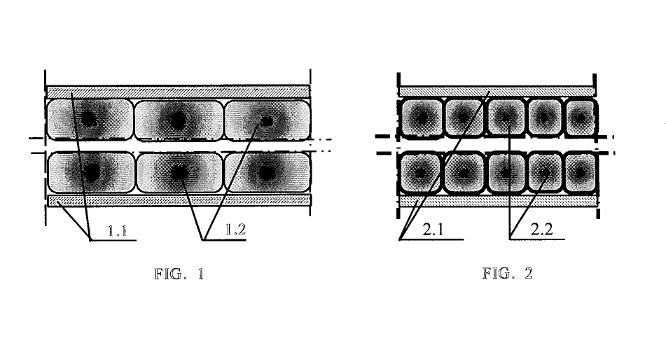

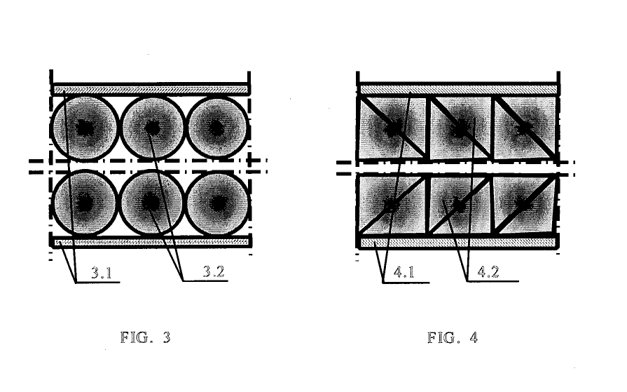

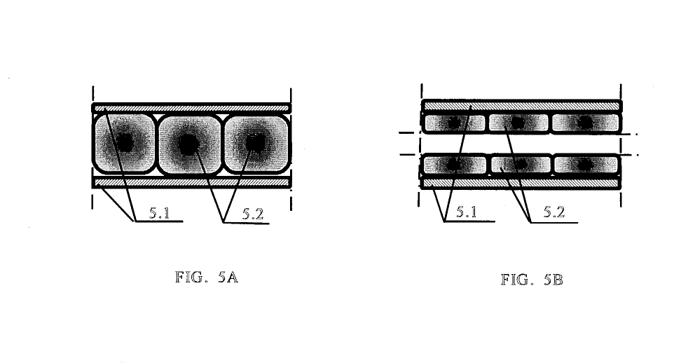

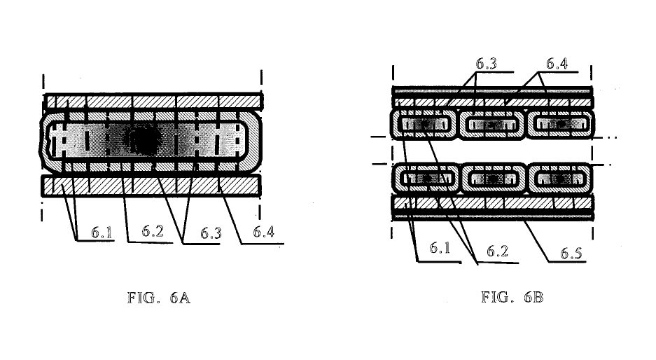

FIG. 9 illustrates possible cross sectional view of glass or plastic bottle covered by protective composition where 9.1 is outside protective fabric; 9.2 are protective sections; 9.3 is a glass bottle; 9.4 is a cork of glass bottle; and 9.5 is a bottle cover made from protective composition.

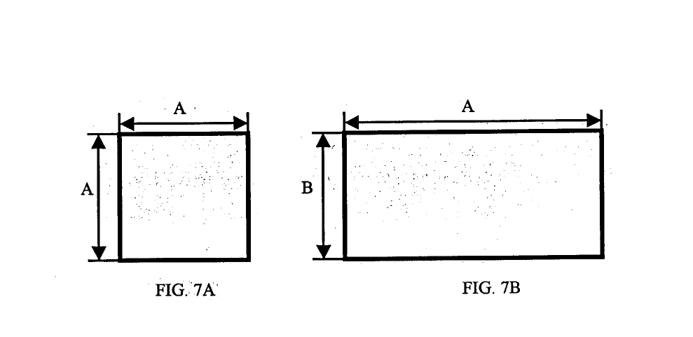

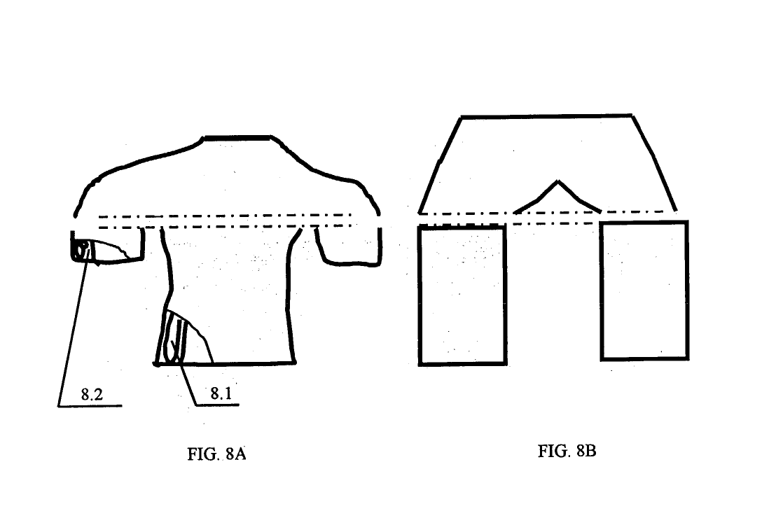

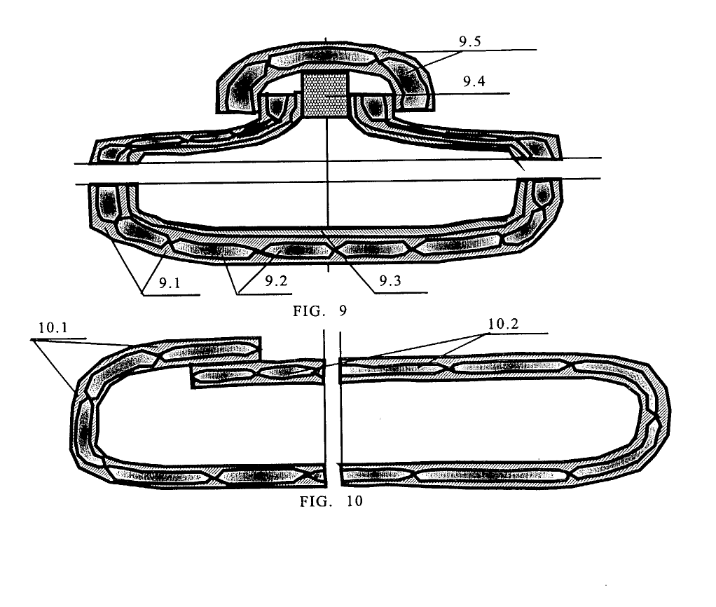

FIG. 10 illustrates cross sectional view of possible sleeping bag made from protective composition where 10.1 is outside protective fabric; and 10.2 are protective sections, and which may have layer of breathable film as disclosed in U.S. Pat. No. 5,043,209 as well as above clothes on FIG. 8.

At the FIGS. from 7 to 10 have shown application of protective compositiom consist of only protective sections and outer fabric without inner fabric. It can be made more easily especially when do not sift the silicon particles, but use the SINGLE-screw-type extruder with particylar size of fence to made particular size of silicon “open” particles as described above. There FIG. 9 is not used a pressure. Also there on FIG. 10 is used a few needed layers of protective sections, and is not used pressure for realize all of silicium “open” as “pop corn” temperature properties. This kind of sleeping bag is used, for example, in extreme climates for severe temperatures.

Also we made three examples (tests) of plastic bottle covered by protective composition, and has above cover made of protective composition as well, and which cross sectional view illustrates on FIG. 9. In each example plastic bottle volume was 20 Fl oz (1.25 PT) 591 ml; each water volume poured inside plastic bottle has 15 Fl oz (0.94 PT) 443 ml; each water temperature inside plastic bottle before each example has 40.degree.F.; and each water temperature inside plastic bottle to the end of each example has 50.degree.F. Each example is realized at room temperature 68 F. (20° C.), and preform of protective sections was at the same temperature. In each example is determine the time (hours and minutes) how long hold above mentioned temperature this volume of water. This time is determined by stopwatch. The temperature of water is determined by temperature couples connected to device shows current substance temperature, actually voltmeter. Thickness of fibers in each example was approximately 0.50 nm. Weight of fibers in each example with fibers was approximately 140 mg/100 mm.sub.2. Cantilever bending lenth of fibers was approximately 25 mm in each example. Strength of fibers was in each example approximately 170 kg.cm//g/cm.sup.2. In each example thickness of “open” silicon particles protective sections were approximately from 0.4 to 3.0 mm . Weight of protective composition was approximately 56 mg/msup.2 for all examples with one layer of protective section was 94 mg/msup.2 for all examples with two layers of protective sections.

### EXAMPLE 1

All of plastic bottle is covered 5 mm ordinary fabric in a few layers and head of plastic bottle is covered the same a few layers 5 mm ordinary material.

How long time holds temperature volume of water this plastic bottle from 40.degree.F. to 50.degree.F.: 1.0 hour.

### EXAMPLE 2

Strength of protective composition (approximately): 42 kg/cm//g/cm.sup.2

Number of layers protective sections: 1

Thickness of protective composition: 6 mm.

How long hold the same volume of water plastic bottle from 40.degree.F. to 50.degree.F.: 1.7 hour.

### EXAMPLE 3

Strength of protective composition (approximately): 53 kg/cm//g/cm.sup.2

Number of layers close up protective sections: 2

Thickness of protective composition: 13 mm.

How long hold plastic bottle temperature the same volume of water from 40.degree.F. to 50.degree.F.: 2.5 hours.

We can see (1) the time depends on ordinary fabric or protective sections we uses already. If there protective section are used than the time is increaced which holds temperature of water. (2) The holding temperature of water depends on number of protective section layer(s) which is used. If there layers of protective section is increaced the time which holds temperature of water is increaced as well.

The protective composition has civil, industrial and military applications. The idea, which, at first glance, might seem strange and which is expressed in features is thermal insulation properties of silicon Si sand. These properties of silicon are used in, for instance, walls of houses and another part of products which used in extreme climates for severe temperatures. A major advantage of protective composition is that the insulator properties of the protective composition may be controlled by the occupant according to the temperature demands of the environments, by varying the amount of air using the small spaces between interior protecting fabrics into which the heat or cool can traversing freely, and which can be closed by next layer of a protective fabric with protective sections of protective composition. For example, FIGS. from 7 to 10 shows the application of protective composition of current invention. Outer wear for cold climates (clothing, apparel, vest, sleeve and glove, mitten), thermal underwear, sleeping and another bags, container, wet suit, firefighters protection clothing and structures does not need to use same protective cloasing and why some firefighters, as an example, sometimes lost their life as we knows it. The new invention is helpful inclosing the above problems, by virtue of a combination of some, or all, of the features.

1. A protective composition which low heat and cool transfer comprising heat and cool transfer porous protective insulator sections, said means being selected from:
(a) at least one layer of said low heat and cool transfer said protective sections in said protective composition;
(b) for said low heat and cool transfer said protective sections the such as silicon (Si) sections are used;
(c) for said low heat and cool transfer said protective sections said are used and can be composed of said porous silicon (Si) sections or any of the said protective materials or synthetic commonly used as said protective composition.

2. A protective composition defined in claim 1 wherein said means that the major advantage of the said protective silicon sections has “open” porous silicon particles while protective silicon sections which “open” porous heat by inflow temperature.

3. A protective composition defined in claim 1 wherein said means that the major advantage of the said protective composition are become stronger of protecting section there with protecting section is not only with said porous silicon (Si) plate but also contains intensified fiber of silicon (Si) which less stronger than sewing nidle.

4. A protective section defined in claim 3 wherein said intensified fiber of silicon (Si) can be right or can cross (intersect) each other at any angle.

5. A protective composition defined in claim 1 wherein said means that the major advantage of the said protective composition are insulator properties of said porous silicon (Si) sections which insulator properties may be controlled by the occupant according to the temperature demands of the environments, by varying the amount of air which can traversing freely between the inner small spaces of said protecting section and fabric, and which can be closed said by next inner also layer of said protective section and said fabric as well.

6. A protective composition defined in claim 1 wherein said means that the thickness and layers of said protective sections is influenced onto in rate of heat/cool transfer said of a protective composition.

7. A protective composition defined in claim 1 wherein said means each said interior fabric, and said means each exterior surrounded protective fabric are heat treated.

8. A protective composition defined in claim 1 wherein said means that said protective composition protect areas where temperature are bellow 1200° C.

9. A protective composition defined in claim 8 wherein said means protective composition may be applied to solve a problem of climate control for product and personnel which are exposed to extreme temperature (environments).

10. A protective composition defined in claim 1 feature (b) wherein said means said protective composition is used of a light weight and said means low heat and cool transfer, for instance, said fine porous silicon (Si) in solid form or molded into said sections.

11. A protective composition defined in claim 1 wherein said means protective composition said webs having at least sections thereof in strip form, oriented randomly in non-planar configurations.

12. A protective composition defined in claim 1 wherein said means protective composition said in porous sections but said means sewing twice together in desired staple length, for instance, said a porous silicon (Si) sections of the proper thickness, as compared to a fabric of currently used material without such said protective composition.

13. A protective composition defined in claim 1 wherein said means protective sections, said wrap inner protective fabric, and said wrap outer protective fabric together.

14. A protective composition defined in claim 1 wherein said means that said protective sections density is varied in thickness of less than 0.5 inch as pressed.

15. A protective composition defined in claim 1 wherein said means that said protective composition outside has an coating as smooth ingradient, for instance, silver (Au).

16. A process to make a protective composition wherein said means said protective composition which consist of said means the protective sections, all of fabrics and all of tread are heat treated if necessary, and then oriented randomly in non-planar configurations.

17. A process to make a protective composition defined in claim 16 wherein said means inner and outer protective fabrics are heat treated or preheated fabrics.

18. A process to make a protective composition defined in claim 16 wherein said means the protective sections are made at least one layer inside protective fabric.

19. A process to make a protective composition defined in claim 16 wherein said means said the protective sections made in the form of superabsorbent particles within a silicon matrix.

20. A process to make a protective composition defined in claim 16 wherein said means local interior protective sections make in the form of semi-rigid or rigid board.

21. A process to make a protective composition defined in claim 16 wherein said means local interior said protective sections are bonded to one another if desired using conventional adhesives, or preferably, needle punched using conventional procedures.

22. A process to make a protective composition defined in claim 16 wherein said means protective fabrics or sections are coated when it needed with smooth ingradient, for instance, silver (Au) or soldering.
